(19) United States
(12) Patent Application Publication
(10) Pub. No.: US 2014/0128147 A1
(43) Pub. Date: May 8, 2014

(54) Method for Performing an Online Multilevel Tournament Duel Game Between Players

(71) Applicants: Chin Feng YU CHENG, Hsinchu City (TW); Chih-Chun CHEN, Taipei City (TW)

(72) Inventors: Chin Feng YU CHENG, Hsinchu City (TW); Chih-Chun CHEN, Taipei City (TW)

(21) Appl. No.: 13/669,121

(22) Filed: Nov. 5, 2012

(51) Int. Cl. A63F 13/12

(52) U.S. Cl. CPC A63F 13/12
USPC 463/25

(57) ABSTRACT

A method for performing an online multilevel tournament duel game between players. The method includes the step of checking whether a player has bought a preset function, wherein the preset function enables the player to preset a plurality of game policies into a network game server and enter the duel game with the plurality of game policies. If yes, an account of the player logins the duel game automatically. Then, it is checked if an opponent player is available on a lowest game level. If with the preset function, one of three duel symbols is automatically selected with one of the plurality of game policies within the preset timeframe. The method further includes the step of comparing the selected duel symbols of the players when the preset timeframe has passed to determine a duel match winner.

### FIELD OF THE INVENTION

The present invention relates to an online duel game, and more particularly to a method for performing an online multilevel tournament duel game between players who are connected to an open network for data and telecommunication through respective computerized devices.

### BACKGROUND OF THE INVENTION

Man has been drawn to games and gambles for fetching the thrill and prospect of easy earnings, and has pursued for the credit given to a winner since the dawn of times.

In modern times, communication networks such as the Internet is, among other things, utilized as a global meeting place for people seeking to gamble and play games against each other or versus “the machine” online, which for example could be a software implemented machine provided by a game server. The popularity of Internet casinos for online poker play against other physical participants is steadily increasing. The players then only have to register an individual player account and provide some betting money to be able to start playing poker against each other online. Internet casinos often offer a variety of other traditional casino games such as blackjack, roulette, fruit machines and so forth, where a man gambles against “the machine”, for the sake of monetary or other rewards given by the casino.

However, people are generally more interested in playing or gambling against one another than against “a machine”, probably because the machines lack of human intelligence, emotions and other such human factors influencing the outcome of a game. Poker and most online games for money between people require a certain degree of skill and game knowledge for a player to be able to play effectively, and the outcome of a game mostly depends on the skill of the players. There is currently short of opportunities for a person who does not want to risk his/her money when he/she lacks such game skills, and is not interested in acquiring such skills through practice, but still wants to participate and experience the thrill of a network game for money against other people.

The ancient game of Rock Paper Scissors, RPS, is a very popular man-to-man game already known by most people at childhood. RPS has traditionally been a decision making game of wits, speed, dexterity and strategy between players who are unable to reach a decision using other means. It is also known in parts of the world as Jenken, Jan Ken Pon, Roshambo, Shnik Shnak Shnuk, Ching Chong Chow, Farggling, Scissors Paper Stone, Scissors Rock Paper, Sten Sax Pase, among many others. The result of a game has been considered a binding agreement between the players. The game is very simple to learn and understand and is played by substituting the elements of Rock, Paper and Scissors with standard hand signals, and it is believed that the game is at least 500 years old or more.

According to the traditional game rules, Rock wins against Scissors, loses to Paper and stalemates against itself. Paper wins against Rock, loses to Scissors and stalemates against itself. Scissors wins against Paper, loses to Rock and stalemates against itself. In other words, Rock smashes or blunts Scissors, Scissors cuts Paper and Paper covers Rock.

The popularity of RPS together with new technology has brought forth some alternative ways of playing the game other than the traditional way of hand signaling. One kind of conventional technique includes a control panel and a display. The display displays a main character and three opponent characters on a game screen. A rock-paper-scissors game button is adapted for selecting the kind of motion (scissors, stone, paper) of the main character and serves as the start button for starting a rock-scissors-paper game. A bet button is also provided on the device for setting gambling rate. Furthermore, a medal slot is provided on the device for inserting medals while a dispensing button and a medal eject hole are provided on the device for taking out medals won.

Another kind of conventional technique comprises a janken battle server connected with terminal devices such as personal computers or mobile appliances through a communication network. The battle server provides a janken battle game through janken cards to participants who have joined from the terminal devices through the communication network. The cards comprise a combination of janken hands indicating the basic characteristics of janken, and characters indicating secondary characteristics by pictures.

Still another kind of conventional technique comprises a scissors-paper-rock game button on respective steps of a left staircase and a right staircase. A player who has won the scissors-paper-rock game climbs one step of the staircase, and a player who has lost comes down one step of the staircase. The player who reaches the uppermost step wins the game.

The prior art systems, methods and devices for performing a game of rock-scissors-paper all lack the means for providing an online multi player tournament duel scenario, where a multitude of players are given the opportunity to meet each other in real-time RPS duels for stakes.

Therefore, there is still a demand for a solution which can solve the aforementioned problem of the conventional techniques.

### SUMMARY OF THE INVENTION

To overcome the aforementioned problem of the conventional techniques, the present invention discloses a method for performing an online multilevel tournament duel game between players.

In one aspect, the present invention provides a method for performing an online multilevel tournament duel game between players who are connected to an open network for data and telecommunication through respective computerized devices, each of which is with a screen, wherein a network game server hosts the duel game and a network game database connected to the server stores at least one of game data and registered player data. The method includes the steps of: receiving game start notifications on the computerized devices, and checking whether an account of a player has bought a preset function or not, wherein the preset function enables the player to preset a set of game policies which include a plurality of game policies into the network game server and enter the duel game with the plurality of game policies in a predetermined sequence. If yes, the account of the player logins the duel game automatically. If no, it is checked if the account of the player logins the duel game within a predetermined time. Subsequently, it is checked if an opponent player is available on a lowest game level. If the account of the player has not bought the preset function, one of three duel symbols is selected by the player within a preset timeframe. If the account of the player has bought the preset function, one of the three duel symbols is automatically selected according to one of the plurality of game policies within the preset timeframe. The method further includes the step of comparing the selected duel symbols of the players when the preset timeframe has passed. If the selected duel symbols upon comparison are found equal, the countdown clock is reset and the duel match is repeated. If the symbols are found not equal, the selected symbol being first to the other symbol selected determines a duel match winner. The winner of at least one duel match advances one level in the game and engages a new duel match on the new game level while the loser of at least one duel match is momentarily eliminated from the multilevel game.

In another aspect, the present invention provides a readable storage medium storing instructions of a computer program which, when executed by a processor, causes the processor to perform a method for performing an online multilevel tournament duel game between players being connected to on an open network for data and telecommunication through respective computerized devices, each of which is with a screen, wherein a network game server hosts the duel game and a network game database connected to the server stores at least one of game data and registered player data. The method includes the steps of: receiving game start notifications on the computerized devices, and checking whether an account of a player has bought a preset function or not, wherein the preset function enables the player to preset a set of game policies which include a plurality of game policies into the network game server and enter the duel game with the plurality of game policies in a predetermined sequence. If yes, the account of the player logins the duel game automatically. If no, it is checked if the account of the player logins the duel game within a predetermined time. Subsequently, it is checked if an opponent player is available on a lowest game level. If the account of the player has not bought the preset function, one of three duel symbols is selected by the player within a preset timeframe. If the account of the player has bought the preset function, one of the three duel symbols is automatically selected according to one of the plurality of game policies within the preset timeframe. The method further includes the step of comparing the selected duel symbols of the players when the preset timeframe has passed. If the selected duel symbols upon comparison are found equal, the countdown clock is reset and the duel match is repeated. If the symbols are found not equal, the selected symbol being first to the other symbol selected determines a duel match winner. The winner of at least one duel match advances one level in the game and engages a new duel match on the new game level while the loser of at least one duel match is momentarily eliminated from the multilevel game.

One advantage of the present invention is that the preset function can enable people in different time zones to play the online multilevel tournament duel game whenever the game starts.

Another advantage of the present invention is that the preset game policies in the network game server may be modified by the player during the game.

Still another advantage of the present invention is that the preset function may be cancelled by the player during the game to play the game manually.

These and other advantages will become apparent from the following description of preferred embodiments taken together with the accompanying drawings and the appended claims.

### BRIEF DESCRIPTION OF THE DRAWINGS

The present invention may be understood by some preferred embodiments and detailed descriptions in the specification and the attached drawings below. The identical reference numbers in the drawings refer to the same components in the present invention. However, it should be appreciated that all the preferred embodiments of the present invention are provided only for illustrating but not for limiting the scope of the Claims and wherein:

FIG. 1 schematically illustrates the connection of hardware components required for performing an online tournament duel game, such as a rock-scissors-paper duel game, between multiple participants in accordance with one embodiment of the present invention;

FIG. 2 schematically illustrates a flowchart for an online tournament duel game of rock-scissors-paper matches between multiple participants for monetary rewards in accordance with one embodiment of the present invention;

FIG. 3 schematically illustrates a flowchart for an online tournament duel game of rock-scissors-paper matches between multiple participants for monetary rewards in accordance with one embodiment of the present invention;

FIG. 4 schematically illustrates a flowchart for an online tournament duel game of rock-scissors-paper matches between multiple participants for monetary rewards in accordance with one embodiment of the present invention;

FIG. 5 schematically illustrates a flowchart for an online tournament duel game of rock-scissors-paper matches between multiple participants for monetary rewards in accordance with one embodiment of the present invention; and

FIG. 6 is a block diagram illustrating the modules in the network game server to perform the method of the present invention in accordance with one embodiment of the present invention.

### DETAILED DESCRIPTION OF THE PREFERRED EMBODIMENT

The present invention will now be described with the preferred embodiments and aspects and these descriptions interpret structure and procedures of the present invention only for illustrating but not for limiting the Claims of the present invention. Therefore, except the preferred embodiments in the specification, the present invention may also be widely used in other embodiments.

The present invention provides a network method for performing an online tournament game of man-to-man duels, for example rock-paper-scissors (RPS) duels or finger-guessing duels, between participants on an open network for data and telecommunication, such as the Internet. The present invention also relates to network software for performing the online game and a readable storage medium storing the network software.

The online game accomplished according the present invention provides the opportunity for a plurality of players to meet each other in duels, such as RPS duels or finger-guessing duels, for stakes. The loser of each duel is momentarily eliminated from the game and loses his/her stake, while the winner of a duel advances to a new game level at which a new duel can be accepted.

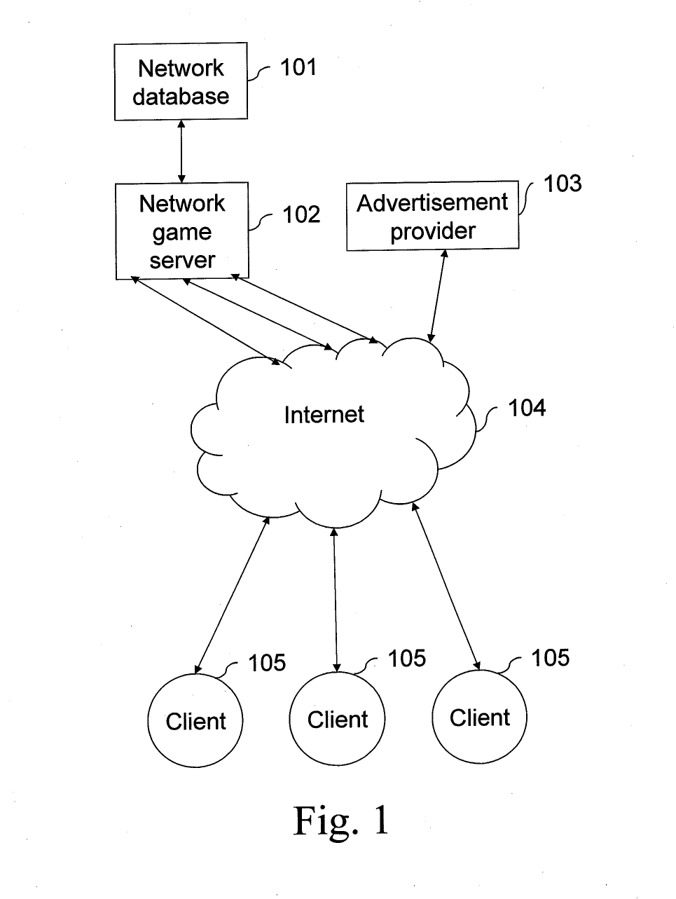

Referring to FIG. 1, according to one embodiment of the present invention, the game is for example provided on an Internet 104 webpage to the screens of clients 105 through a network game server 102 connected to a network database 101 which stores both personal data and game data of game participants. A person who wants to participate in a game, for example, enters the portal or webpage on which the game is hosted and run graphically through the server software via a client, such as computerized device provided with a digital screen and connected wirelessly or through cable to the network, such as the Internet. An advertisement provider 103 is coupled to the network game server 102 through the internet 104 to provide advertisements to the network game server 102, so as to show the advertisements on the screens of the clients 105. When the player clicks the advertisement shown on his/her screen, the game site owner will make some money.

The web-based tournament game offers a number of simultaneous participants, who are connected to the game server hosted webpage through their respective computerized devices with screens, the opportunity to compete and play against one another for a reward, which could be a valuable or monetary reward, in a series of man-to-man duels. The duels are for example decided through rock-scissors-paper matches, Janken matches or finger-guessing matches according to one embodiment of the present invention.

The game comprises a number of levels, and a participant only duel with an opponent who currently is on the same level except the highest level, i.e. the championship. The first participant who has, for example, one partial victory in a duel wins the duel and advances to the next level, while the loser forfeits his/her stake and is eliminated from the game. When a deuce comes out, the duel will re-start until a predetermined number of deuces, for instance ten deuces, happen continuously. While the predetermined number of deuces happen successively for certain two players, the two players, i.e. the participant and the opponent, will be eliminated from the game. At the championship, there may be two or three players. When there are two players at the championship, the two players enter the dual. When there are three players at the championship, the three players enter the dual two by two. The player who wins two duals is the winner(champion), and the winner wins the championship and gets the award. In one embodiment of the present invention, there may be one or more players who win the championship at the same time.

In one embodiment of the present invention, there may be a plurality of games which are held by the system during a predetermined period of time, for instance, one month, six months or one year, etc. When a particular player wins several duel matches in different games held at different time but does not win the championship in every game he/she joins, if the accumulated number of duel matches in which the particular player wins during the predetermined period of time is larger than a predetermined threshold number, the particular player may get the award, so as to encourage the players who join multiple games but fail to win the championship in every game they join.

The courses of events of a game are graphically illustrated in a main game window, according to one embodiment of the present invention. In one embodiment of the present invention, a registering procedure has to be completed before allowing a new participant to have access to the game. The player may register without any fee. A player registration means then provides a new participant with a registration fill-in form online through the game webpage. The registration fill-in form, for example, may include fields for filling in personal data, such as name, address, age, etc. When playing for valuables, such as money or monetary rewards, the fill-in form also includes fields for filling in financial data, such as bank account, credit card number or the like. Thus, the submitted personal and financial data together with a username and password chosen by the participant forms the individual player account. The data of the registered player account is stored in the network game database 101. Considering the right of people in different time zones to join the game, since the tournament duel game of the present invention starts at a globally identical absolute time, the player may choose whether to buy a preset function or not at the registering procedure or when playing the game. In one embodiment of the present invention, the tournament duel game of the present invention may be held globally or regionally. If the player chooses to buy the preset function, the player may preset a set of game policies which may include a plurality of desired game policies into the network game server 102. In one embodiment, the desired preset game policies may be arranged in a predetermined sequence which is determined by the player. Then, the account of the player who buys the preset function will login the game automatically if the player fails to join the game in time when the game starts and enter the duel according to the preset game policies in the predetermined sequence. The account of the player who buys the preset function will enter the duel by utilizing the plurality of preset game policies according to the predetermined sequence. For example, the account of the player who buys the preset function will enter the first duel match by utilizing the first game policy of the plurality of preset game policies. If a deuce happens in the first duel match, the second game policy of the plurality of preset game policies may be employed to continue the first duel match. If no deuce happens and the player wins and moves up one level, the second game policy of the plurality of preset game policies may be employed to enter the second duel match, and so forth. In one embodiment of the present invention, the number of the preset game policies is larger than the predetermine number of deuces, for instance ten, thirty or more. The preset policies may be modified by the player or be cancelled by the player to play manually when playing the game.

A data checkup procedure is preferably performed through a data authenticating means, wherein the authenticity of the registered data of the player account is verified according to known procedures for data authentication, before access can be granted to a tournament duel game involving gambling for valuables. Every player starts from the basic level.

A player who arrives at a level through winning a duel is, through a player pairing means, automatically paired with an available opponent player for a duel. A duel window, where the duel will take place, is then simultaneously opened up on the respective screens of both dueling participants' computerized devices through a dueling means. The duel window displays at least one of personal data, which are fetched from the database stored with player account and may comprise the respective participants name and/or username and the like personal information, a dialog box which displays duel buttons, duel win indicating means in the form of mark spots and remaining duel time graphically. In the preferred embodiment of the tournament duel game, the duel buttons display a respective image of a rock, a scissor and a paper.

In one embodiment of the present invention, an extra chat box or the like communicating means is provided through a messaging means for the participants to chat with one another during a duel and/or when waiting for a duel. The messaging means is, for example, realized through ICO, SMS, email, or the like, which is known means for real time or time delayed messaging. Alternatively, the messaging means is realized through known means for voice connection between the participants, who engage in or wait for a duel, through headsets or loudspeakers and microphones connected to their respective computerized devices. In the preferred embodiment of the game comprising RPS duels, when the three alternative duel buttons with the respective symbols rock, scissors and paper are displayed by the dueling means, the participants have a preset amount of time to choose either one of the three symbols by pressing the corresponding button. The remaining time is then shown by a graphically diminishing bar or line at the bottom of the dialog box. When both participants have chosen a button, the choices are displayed by the dueling means, and if it is not a mirror play, then the winner has won the duel.

The loser is then, through an eliminating means, eliminated from the game. A level advancing means provides that the winning player reaches the next game level. The duel window is momentarily closed on the screen of the loser.

A lobby interface means, in a further embodiment of the present invention, provides a game interface, through which a participant is provided the means to personally adjust the settings of a game, such as to enable/disable sound, chat and/or talk with other participants through means for real time or time delayed messaging as those described above.

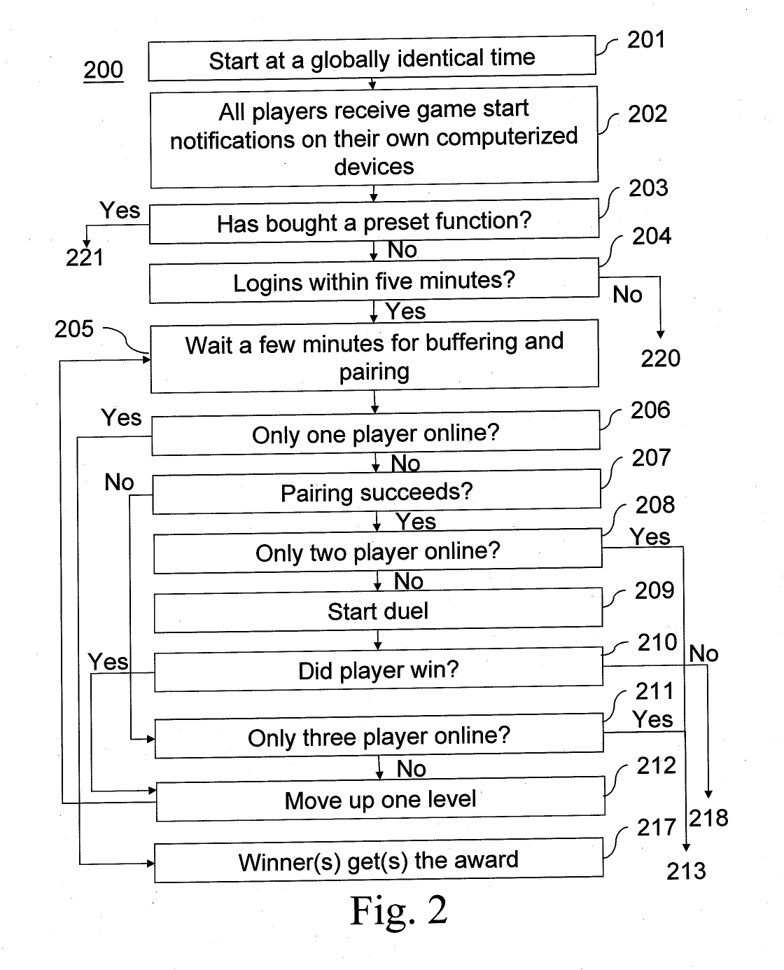

FIG. 2, according to one embodiment of the present invention, schematically depicts a flowchart of events, provided through software means, in a tournament duel game 200 comprising rock, scissors and paper matches between multiple participants on an Internet webpage, to which the participants have access through their respective network connected personal computerized devices with screens. A player who is registered without fee and authenticated for a duel game, for example according to the steps described above, starts the duel on the lowest(basic) levels. At step 201, the game starts at a globally identical absolute time. Subsequently, at step 202, all players who have registered will receive game start notifications on their own computerized devices. Then, at step 203, it will be checked whether the players have bought a preset function or not. If yes, continue to step 221. If no, continue to step 204. At step 204, it is checked whether the players who have not bought the preset function login the game website within a predetermined time, for example five minutes, or not. If yes, continue to step 205. If no, continue to step 220. At step 205, there is a short wait, for example of a few minutes for buffering and pairing the players. Subsequently, at step 206, it is checked whether there is only one player remained online or not. If yes, continue to step 217. If not, continue to step 207.

At step 207, it is checked whether the pairing procedure succeeds or not. If yes, continue to step 208. If no, continue to step 211. At step 208, it is checked whether there are only two players remained online or not. If yes, continue to step 213. If no, continue to step 209. At step 209, the paired players start the duel. A duel window with a dialog box is opened simultaneously on the computerized screens of both of the paired players through the dueling means and prompts each of these participants to pick a rock, scissors or paper symbol illustrated graphically via three different buttons in the box within a set countdown time illustrated by a graphically diminishing bar or line. There is a short wait, for example between 2 to 10 seconds, before countdown is over. Then, at step 210, it is checked whether one specific player wins or not. The symbol chosen by one of the players is compared to that chosen by the other of the players for “equality” through a symbol comparing means to see if one of the paired players wins the duel match. If the symbol chosen by one specific player is not equal to that chosen by the other player and if the symbol selected by the specific player is first to the other symbol selected by the other player, it is determined that the specific player wins the duel match and the specific player who wins the duel match continues to step 212. If no, continue to step 218. At step 211, it is checked whether there are only three players remained online or not. If yes, continue to step 213. If no, continue to step 212. At step 212, the player(s) move(s) up one level, and continue to step 205.

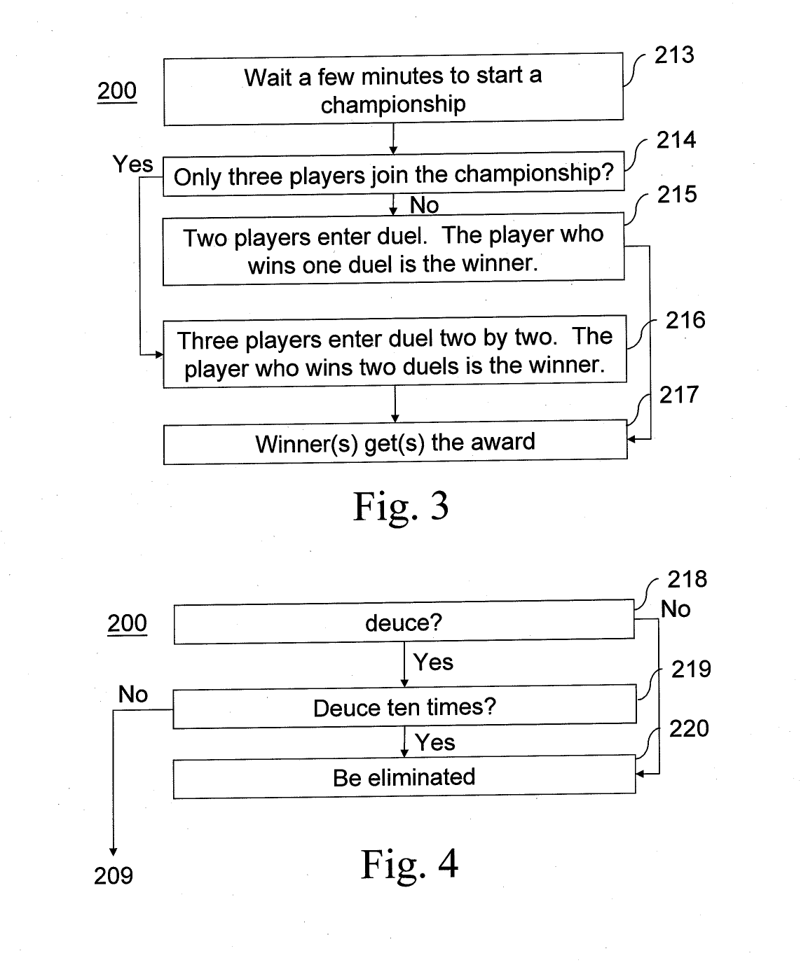

As shown in FIG. 3, at step 213, there is a short wait, for example of a few minutes to start a championship. Then, at step 214, it is checked whether only three players join the championship or not. If yes, continue to step 216. If no, continue to step 215. At step 215, the two players enter the duel, and the player who wins one duel is the winner. Subsequently, at step 217, winner(s) get(s) the award. In one embodiment, there may be one winner. In another embodiment, there may be more than one winner. At step 216, the three players enter duel two by two, and the player who wins two duels is the winner, so as to continue to step 217.

With reference to FIG. 4, at step 218, it is checked whether the paired players deuce or not. If yes, continue to step 219. If no, continue to step 220. At step 219, it is checked whether the paired players deuce a predetermined number of times, for example ten times, continuously or not. If yes, continue to step 220. If no, continue to step 209. At step 220, the player who loses the duel match or the players who deuce a predetermined number of times are eliminated from the game.

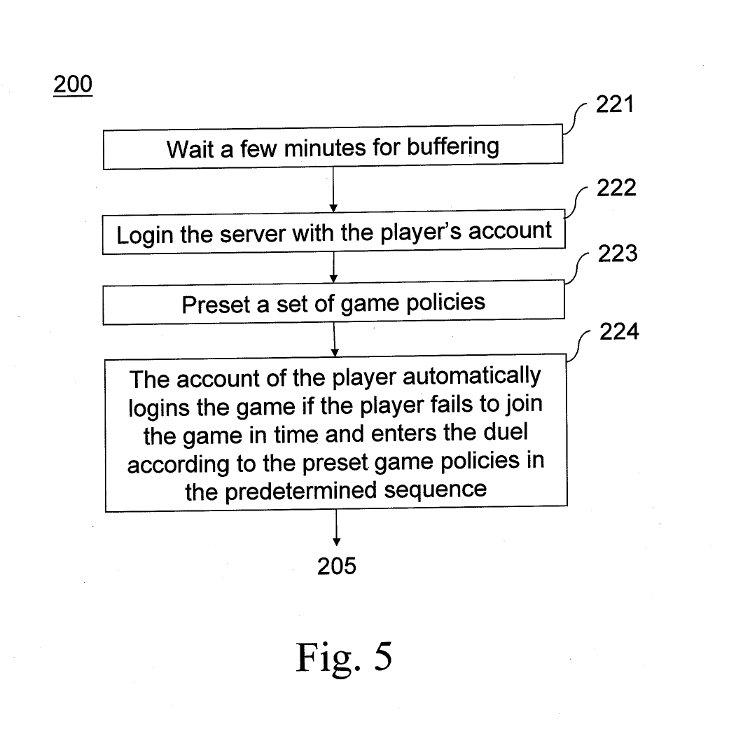

As shown in FIG. 5, at step 221, there is a short wait, for example of a few minutes for buffering. Then, at step 222, the player logins the network game server with the player's account. Subsequently, at step 223, the player may preset a set of game policies which may include a plurality of game policies into the network game server, where a predetermined sequence of the plurality of game policies may be determined by the player. In one embodiment of the present invention, the number of the preset game policies may be larger than the predetermine number of deuces, for instance eleven, thirty or more. Then, at step 224, the account of the player who buys the preset function will login the game automatically if the player fails to join the game in time when the game starts and enter the duel according to the preset game policies in the predetermined sequence, and continue to step 205.

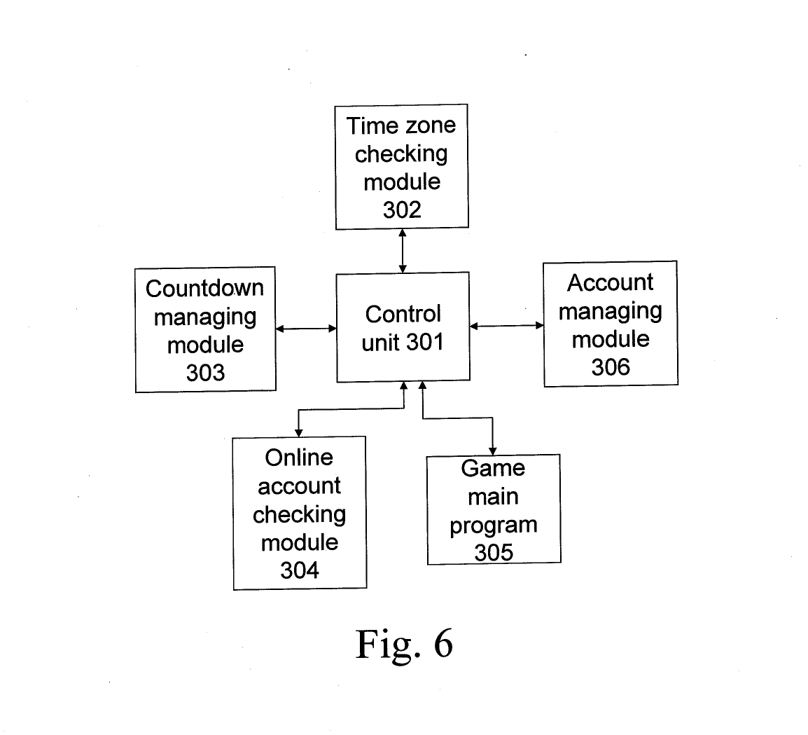

Furthermore, FIG. 6 is a block diagram illustrating the exemplary modules in the network game server to perform the method of the present invention in accordance with one embodiment of the present invention. As shown in FIG. 6, a control unit 301 may be configured in the network game server. A time zone checking module 302 is coupled to the control unit 301 to check the time zone of the players when the players login. A countdown managing module 303 is coupled to the control unit 301 to manage the countdown procedure in the tournament duel game. An online account checking module 304 is coupled to the control unit 301 to check how many accounts of the players are online or check if the accounts of the players login within a predetermined time. Moreover, a game main program 305 is coupled to the control unit 301 to construct the graphic interfaces of the tournament duel game and operate the tournament duel game. An account managing module 306 is coupled to the control unit 301 to manage the accounts of the players and the setting related to the accounts of the players.

Accordingly, the present invention provides means for performing a real time network multi player tournament duel game for a reward, which requires a minimum of forehand knowledge and skill and is quick, fun and exciting to play, through above described embodiments.

Means or modules mentioned in the present description can be software, hardware or a combination of both.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof

What is claimed is:

1. A method for performing an online multilevel tournament duel game between players who are connected to an open network for data and telecommunication through respective computerized devices, each with a screen, wherein a network game server hosts said duel game and a network game database connected to said server stores at least one of game data and registered player data, the method comprising the steps of:
receiving game start notifications on said computerized devices;
checking whether an account of a player has bought a preset function or not by an account managing module, wherein said preset function enables said player to preset a set of game policies which include a plurality of game policies into said network game server and enter said duel game with said plurality of game policies in a predetermined sequence;
if yes, said account of said player logging in said duel game automatically;
if no, checking if said account of said player logins said duel game within a predetermined time by an online account checking module;
checking if an opponent player is available on a lowest game level;
if said account of said player has not bought said preset function, selecting one of three duel symbols within a preset timeframe;
if said account of said player has bought said preset function, automatically selecting one of said three duel symbols according to one of said plurality of game policies within said preset timeframe;
comparing the selected duel symbols of the players when said preset timeframe has passed, wherein if the selected duel symbols upon comparison are found equal, the countdown clock is reset by a countdown managing module and the duel match is repeated, and wherein if the symbols are found not equal, the selected symbol being first to the other symbol selected determines a duel match winner; and
wherein the winner of at least one duel match advances one level in the game and engages a new duel match on the new game level, wherein the loser of said at least one duel match is momentarily eliminated from said multilevel game.

2. The method of claim 1, further comprising:
checking if there are only two or three players remained online by said online account checking module;
if yes, starting a championship;
checking if only three players join the championship by said online account checking module;
if yes, three players engaging a duel match two by two and the player who wins two duel matches being a champion; and
if no, two players engaging a duel match and the player who wins one duel match being said champion.

3. The method of claim 1, before receiving game start notifications on said computerized devices, further comprising:
starting said online multilevel tournament duel game at a globally identical absolute time.

4. The method of claim 1, wherein if the selected duel symbols of the players are found equal continuously up to a predetermined number of times while the duel match is repeated, the players who deuce continuously up to said predetermined number of times are momentarily eliminated from said multilevel game.

5. The method of claim 4, wherein a number of said plurality of game policies is larger than said predetermined number of times.

6. The method of claim 1, wherein the player who first wins one duel match wins the duel.

7. The method of claim 1, further comprising the step of modifying said plurality of preset game policies in said network game server.

8. The method of claim 1, further comprising the step of adjusting settings of the game.

9. The method of claim 1, wherein the player buys said preset function when registering said account or during the game.

10. The method of claim 1, wherein there are a plurality of games held during a predetermined period of time, each of said plurality of games comprising a plurality of duel matches, and if an accumulated number of duel matches in which one particular player wins during said predetermined period of time is larger than a predetermined threshold number, said particular player get an award.

11. A readable storage medium storing instructions of a computer program which, when executed by a processor, causes said processor to perform a method for performing an online multilevel tournament duel game between players being connected to on an open network for data and telecommunication through respective computerized devices, each with a screen, wherein a network game server hosts said duel game and a network game database connected to said server stores at least one of game data and registered player data, the method comprising the steps of:
receiving game start notifications on said computerized devices;
checking whether an account of a player has bought a preset function or not, wherein said preset function enables said player to preset a set of game policies which include a plurality of game policies into said network game server and enter said duel game with said plurality of game policies in a predetermined sequence;
if yes, said account of said player logging in said duel game automatically;
if no, checking if said account of said player logins said duel game within a predetermined time;
checking if an opponent player is available on a lowest game level;
if said account of said player has not bought said preset function, selecting one of three duel symbols within a preset timeframe;
if said account of said player has bought said preset function, automatically selecting one of said three duel symbols according to one of said plurality of game policies within said preset timeframe;
comparing the selected duel symbols of the players when said preset timeframe has passed, wherein if the selected duel symbols upon comparison are found equal, the countdown clock is reset and the duel match is repeated, and wherein if the symbols are found not equal, the selected symbol being first to the other symbol selected determines a duel match winner; and
wherein the winner of at least one duel match advances one level in the game and engages a new duel match on the new game level, wherein the loser of said at least one duel match is momentarily eliminated from said multilevel game.

12. The readable storage medium of claim 11, further comprising:
checking if there are only two or three players remained online;
if yes, starting a championship;
checking if only three players join the championship;
if yes, three players engaging a duel match two by two and the player who wins two duel matches being a champion; and
if no, two players engaging a duel match and the player who wins one duel match being said champion.

13. The readable storage medium of claim 11, before receiving game start notifications on said computerized devices, further comprising:
starting said online multilevel tournament duel game at a globally identical absolute time.

14. The readable storage medium of claim 11, wherein if the selected duel symbols of the players are found equal continuously up to a predetermined number of times while the duel match is repeated, the players who deuce continuously up to said predetermined number of times are momentarily eliminated from said multilevel game.

15. The readable storage medium of claim 14, wherein a number of said plurality of game policies is larger than said predetermined number of times.

16. The readable storage medium of claim 11, wherein the player who first wins one duel match wins the duel.

17. The readable storage medium of claim 11, further comprising the step of modifying said plurality of preset game policies in said network game server.

18. The readable storage medium of claim 11, further comprising the step of adjusting settings of the game.

19. The readable storage medium of claim 11, wherein the player buys said preset function when registering said account or during the game.

20. The readable storage medium of claim 11, wherein there are a plurality of games held during a predetermined period of time, each of said plurality of games comprising a plurality of duel matches, and if an accumulated number of duel matches in which one particular player wins during said predetermined period of time is larger than a predetermined threshold number, said particular player get an award.
